(19) United States
(12) Patent Application Publication
(10) Pub. No.: US 2008/0024502 A1
(43) Pub. Date: Jan. 31, 2008

(54) Document editing device, program, and storage medium

(75) Inventors: Atsushi Nagahara, Chino (JP); Hitoshi Yamakado, Hino (JP); Yu Gu, Fuchu (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/825,096

(22) Filed: Jul. 3, 2007

Related U.S. Application Data
(60) Provisional application No. 60/821,187, filed on Aug. 2, 2006.

(30) Foreign Application Priority Data
Jul. 5, 2006 (JP) 2006-185941
Apr. 26, 2007 (JP) 2007-116872

(51) Int. Cl. G06T 11/00

(52) U.S. Cl. 345/472

(57) ABSTRACT

[OBJECT] To create a document including an object (or objects) having a beautiful well-balanced layout even if a volume of the object (objects) changes

[MEANS FOR ACHIEVING THE OBJECT] The present invention provides a document edit device including: object obtaining means that obtains an object as data expressing at least one of a text and an image; and object edit means that edits the object so that, based on a volume of the object obtained by the object obtaining means, the object is located within an area of a golden rectangle having two adjacent edges whose lengths form a golden ratio.

### TECHNICAL FIELD

The invention relates to a technique for automatically creating a layout when editing a document.

### BACKGROUND ART

There are known techniques for editing a document including an object such as a text (character string) or an image converted into data. For example, Patent Document 1 discloses a technique for locating a text within a definite text area. Patent Documents 2 to 5 disclose techniques for creating a document with a well-balanced layout which is perceived as being beautiful by the human eye.

[Patent Document 1] JP-A 2002-297571

[Patent Document 2] JP-A 8-180037

[Patent Document 3] JP-A 10-289262

[Patent Document 4] JP-A 10-301980

[Patent Document 5] JP-A 2000-200354

### DISCLOSURE OF THE INVENTION

### Object to be Achieved by the Invention

However, there is a problem in that, beauty or layout balance of a generated document varies depending on a volume of objects to be laid out.

The present invention provides a technique for creating a document including objects arranged in a beautiful and well-balanced layout even if a volume of input objects varies.

### Means for Achieving the Object

To achieve the above object, according to the invention, there is provided a document edit device including: object obtaining means that obtains an object as data expressing at least one of a text and an image; and object edit means that edits the object so that, based on a volume of the object obtained by the object obtaining means, the object is located within an area of a golden rectangle having two adjacent edges whose lengths form a golden ratio. This document edit device is capable of creating a document including objects laid out on the basis of a golden ratio.

In a desirable mode, the document edit device can be configured so as to further include attribute information obtaining means that obtains object attribute information related to the object obtained by the object obtaining means, from a storage means storing object attribute information indicating attributes of objects, wherein the object edit means determines a size of the golden rectangle, based on a volume of the object and the object attribute information obtained by the attribute obtaining means. This document edit device is capable of creating a document including an object located in a golden rectangle having a size which is determined based on a volume or an attribute of the object.

In another desirable mode, the document edit device can be configured so as to further include object area obtaining means that obtains information indicating an object area which limits an area where the object obtained by the object obtaining means is to be located, within a layout area according to an area equivalent to an output unit of a document edited by the document edit device, wherein the object edit means determines a size of the golden rectangle so that the golden rectangle is contained in the object area obtained by the object area obtaining means. This document edit device is capable of creating a document including an object located within a golden rectangle which is contained in an object area.

In still another mode, this document edit device can be configured so as to further include layout determination means that lays out the golden rectangle within the layout area.

In still another mode, the document edit device can be configured so as to further include: attribute information obtaining means that obtains object attribute information related to the object obtained by the object obtaining means, from a storage means storing object attribute information indicating attributes of objects; largest golden rectangle determination means that determines a largest golden rectangle as a golden rectangle whose major or minor edge is equal to any of the edges of the object area, within the object area; and determination means that determines whether or not the object fits into the largest golden rectangle determined by the largest golden rectangle determination means, characterized in that if the determination means determines that the object does not fit into the largest golden rectangle, the object edit means changes the object attribute information. This document edit device is capable of creating a document including an object located within a golden rectangle which is contained in an object area.

Also according to the invention, there is provided a document edit method including: an object obtaining step that obtains an object as data expressing at least one of a text and an image; and an object edit step that edits the object so that, based on a volume of the object obtained, the object is located within an area of a golden rectangle having two adjacent edges whose lengths form a golden ratio.

Further, according to the invention, there is provided a program causing a computer device to function as: object obtaining means that obtains an object as data expressing at least one of a text and an image; and object edit means that edits the object so that, based on a volume of the object obtained by the object obtaining means, the object is located within an area of a golden rectangle having two adjacent edges whose lengths form a golden ratio. This program is capable of providing a document which includes an object which is located on the basis of a golden ratio.

Still further, according to the invention, there is provided a storage medium which stores the program described above.

### BEST MODE FOR CARRYING OUT THE INVENTION

### 1. First Embodiment

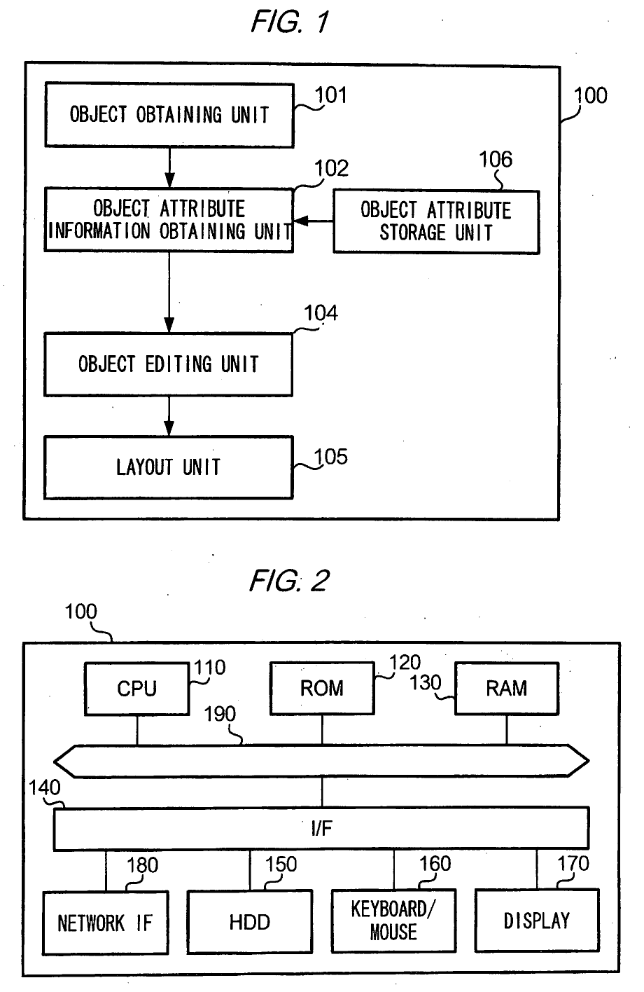

FIG. 1 is a block diagram showing a functional structure of a document edit device 100 according to a first embodiment of the invention. An object obtaining unit 101 obtains an object as a processing target. An “object” refers to data expressing at least one of a text (or a character string) and an image. The object can be obtained from a storage unit (not shown) in the document edit device 100 or from a device other than the document edit device 100. An object attribute storage unit 106 stores object attribute information with respect to at least one object. The object attribute obtaining unit 102 obtains object attribute information related to an object as a processing target. The object edit unit 104 edits the object so that the object is located within a golden rectangular area, at least based on a volume of the object as the processing target. The layout unit 105 locates the object as a processing target within a generated golden rectangle. A “golden rectangle” refers to a rectangle having two adjacent edges, the lengths of which form a ratio (a so-called golden ratio) expressed by the following formula (1). In formula (1), the left and right sides can be replaced by each other.

$$\begin{matrix}[ Math 1 ] & \\ 1 \text{:} \frac{1 + \sqrt{5}}{2} & ( 1 )\end{matrix}$$

FIG. 2 is a block diagram showing a hardware structure of the document edit device 100. A CPU (Central Processing Unit) 110 is a control device which controls components of the document edit device 100. A ROM (Read Only Memory) 120 is a storage device which stores data and programs required for starting up the document edit device 100. A RAM (Random Access Memory) 130 is a storage device which functions as a work area when the CPU 110 executes programs. Through an I/F (Interface) 140, data and control signals are input/output from/to various input/output devices and storage devices. A HDD (Hard Disk Drive) 150 is a storage device which stores various programs and data. As far as this embodiment is concerned, the HDD 150 stores a document edit program for editing documents. A keyboard/mouse 160 is an input device with which a user inputs instructions to the document edit device 100. A display 170 is an output device which displays content of data or processing status. In this embodiment, the display 170 displays objects, layout areas, and grid lines. A network IF 180 is an interface for transmitting/receiving data to/from other devices connected through a network (not shown). The document edit device 100 is capable of, for example, receiving a document (more exactly, electronic data expressing a document) through the network and the network IF 180. The CPU 110, ROM 120, RAM 130, and I/F 140 are connected via a bus 190. As the CPU 110 executes the document edit program, the document edit device 100 establishes the functional structure as shown in FIG. 1.

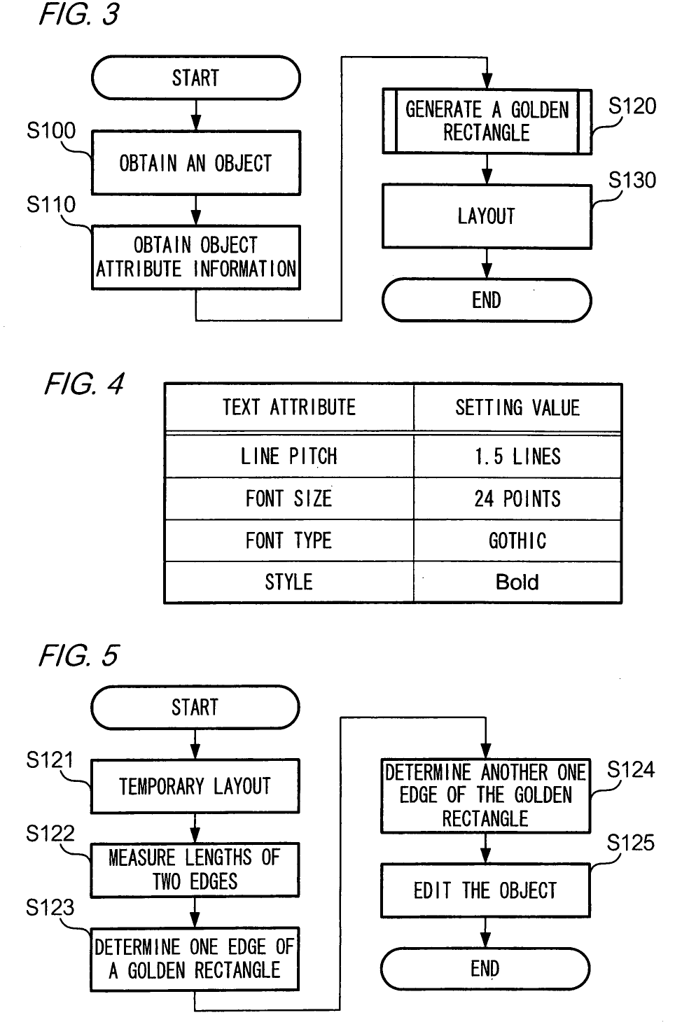

FIG. 3 is a flowchart showing operation of the document edit device 100. In a step S100, the CPU 110 obtains an object as a processing target to be processed. The object can be obtained from a HDD 150 or from a device other than the document edit device 100 through a network and the network IF 180. Otherwise, a user can operate the keyboard/mouse 160 to input an object to the document edit device 100. In this embodiment, text data including a character string as follows is obtained as an object as a processing target. “A next generation printer XXX will be on sale on YY/ZZ (month/date). This printer enables high-speed printing and supports 2-way sheet feed and double-side printing as standard equipment, and simultaneously achieves space and energy saving, that is, an epoch-making product”.

In a step S110, the CPU 110 obtains object attribute information. In this embodiment, the HDD 150 stores object attribute information for each of a plurality of objects. Each object can include an identifier which specifies related object attribute information. The CPU 110 can obtain related object attribute information on the basis of an identifier included in an object as a processing target.

FIG. 4 shows an example of the obtained object attribute information in this embodiment. The object attribute information includes plural data sets, each of which includes an attribute identifier indicative of a type of attribute and an attribute value. In the example shown in FIG. 4, the object attribute information includes “line space”, “font size”, “font type”, and “style” as attribute identifiers, as well as “1.5 lines”, “24 points”, “Gothic”, and “Bold” as values for the attributes, respectively. The attribute “line space” refers to an interval between text lines. The attribute “font size” refers to a size of a font. The attribute “font type” refers to a type of font. The attribute “style” refers to a style of an object when the object is displayed, e.g., regular, italic, or bold.

Description will now be made referring again to FIG. 3. In a step S120, the CPU 110 generates a golden rectangle. In this step, when an object as a processing target is located, location information of the object is generated so that a figure circumscribed to the object becomes a golden rectangle.

FIG. 5 is a flowchart showing details of a process of forming a golden rectangle according to the first embodiment. In a step S121, the CPU 110 temporarily lays out the object as a processing target. An area in which the object as a processing target is laid out, i.e., a layout area is determined in advance. Alternatively, a layout area can be determined in accordance with an instruction input by a user. Also alternatively, a layout area can be determined in accordance with a predetermined algorithm by the CPU

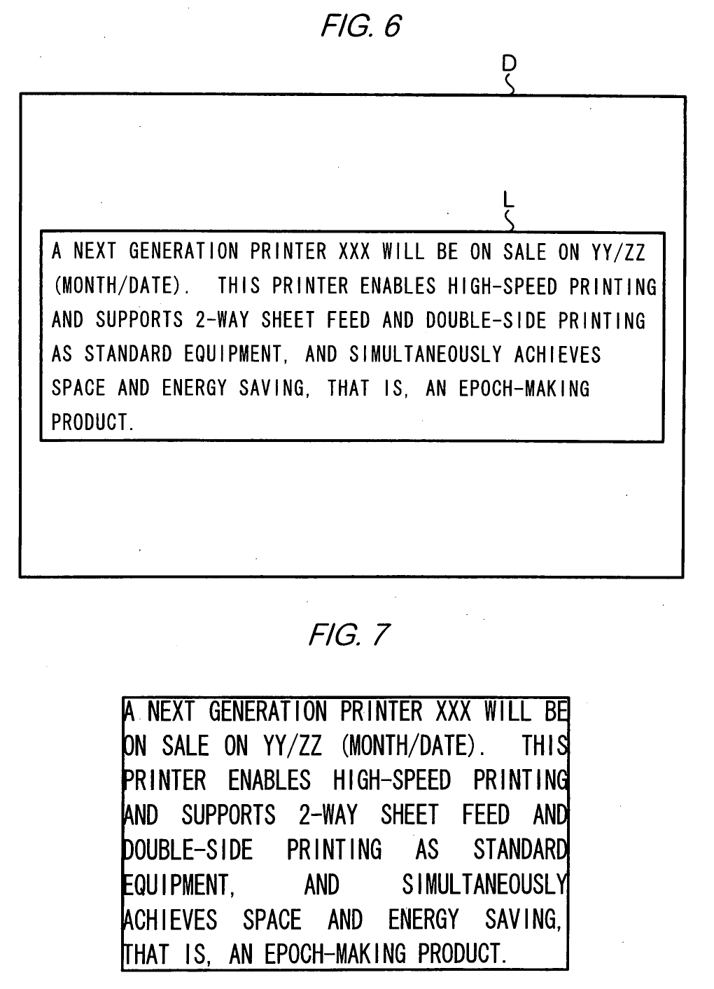

FIG. 6 shows an example of an object which has been temporarily laid out. For example, a layout area D has an A4 size. An object area L indicates an area in which an object as a processing target is located within the layout area D. That is, the object area limits an area where an object should be located within the layout area equivalent to an output unit (e.g., a page) of a document edited by the document edit device 100. The object area L is determined on the basis of a volume of the object as a processing target (e.g., the number of text characters) and object attribute information. For example, the object area L is determined by locating a text in accordance with object attribute information, relative to a point (e.g., a center point) of the layout area regarded as a reference. Specifically, a character string of an object is located in accordance with the line space font size, font type, and style which are specified by object attribute information. At this time, in order that a temporary layout reflects influence from the line space, the layout area is determined so as to display the character string over plural lines. For example, a rule is predetermined so that a character string should be arranged so that it continues through four lines in a temporary layout. The CPU 110 locates the character string and determines the layout area D in accordance with this rule. The temporary layout can be virtually created on the RAM 130. Alternately, a result of the temporary layout can be displayed on the display 170.

Description will now be made referring again to FIG. 5. In a step S122, the CPU 110 measures length of two edges of the object area L, which are width w and height h. For example, the CPU 110 obtains, firstly a rectangle circumscribed to an object (text). The CPU 110 measures the width and height of the obtained circumscribed rectangle. At this time, the CPU 110 can provide a predetermined blank space around the object. The CPU 110 can obtain the circumscribed rectangle including the blank space. Alternately, the CPU 110 can set a text box capable of containing a text which has been laid out temporarily, and can then obtain the width and height of the text box.

In a step S123, the CPU 110 calculates a length A of an edge of a golden rectangle in accordance with formula (2) below.

$$\begin{matrix}[ Math 2 ] & \\ A = \sqrt{\frac{2 \times w \times h}{1 + \sqrt{5}}} & ( 2 )\end{matrix}$$

Formula (2) is obtained on the basis of formula (3) below. Formula (3) is derived from a condition in that the area of the object area L is equal to the area of the golden rectangle.

$$\begin{matrix}[ Math 3 ] & \\ A \times \frac{1 + \sqrt{5}}{2} A = w \times h & ( 3 )\end{matrix}$$

In a step S124, the CPU 110 calculates a length A′ of another edge of the golden rectangle in accordance with formula (4) below.

$$\begin{matrix}[ Math 4 ] & \\ {A}^{′} = \frac{1 + \sqrt{5}}{2} A & ( 4 )\end{matrix}$$

In a step S125, the CPU 110 edits the object so as to be located within the golden rectangle. This editing is carried out as follows. The CPU 110 locates characters included in the object as a processing target in order from the top of the characters. When the total width of located characters reaches A′, the CPU 110 then enters a return key. In a similar manner, characters are located in the second line. When the total width of the characters located in the second line reaches A′, the CPU 110 then enters a return key again. In this manner, an object is obtained with characters located in a golden rectangle.

Otherwise, the CPU 110 can determine an area having the height A and width A′ as a text area or text box. Into the text area, the CPU 110 pours the character string included in the object. That is, an object located in the golden rectangle can be obtained by locating characters so as to be contained in the text area.

FIG. 7 shows an example of a formed golden rectangle. Thus, an object is located so as to be contained in a golden rectangle.

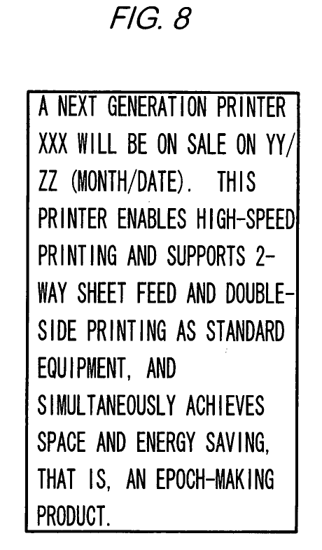

FIG. 8 shows another example of a golden rectangle. Although FIG. 7 shows an example of a wide golden rectangle, there can be a tall golden rectangle. Alternately, which of vertical and horizontal edges should be a major edge can be determined in advance. Also alternately, which of a vertical or a horizontal edge should be a major edge can be determined in accordance with an instruction input by a user. Still also alternately, which of a vertical or a horizontal edge should be a major edge can be determined by the CPU 110 in accordance with a predetermined algorithm.

Description will now be made referring again to FIG. 3. In a step S130, the CPU 110 locates the object located in a golden rectangle, into the layout area D. The position at which the object should be located can be determined in advance. Alternately, the position at which the object should be located can be determined in accordance with an instruction input by a user. A document is generated as the object as a processing target is located.

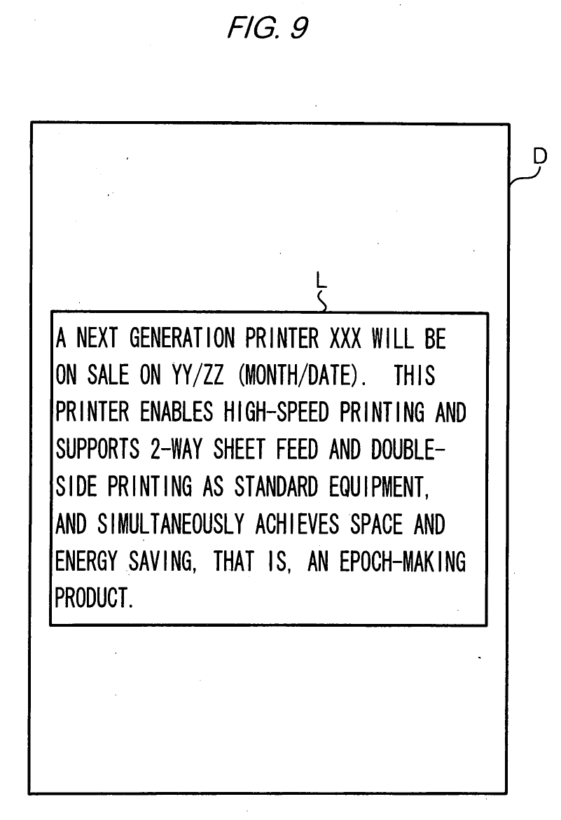

FIG. 9 shows an example of a generated document. Thus, a document with a well-balanced layout can be obtained.

In the above embodiment, the CPU obtains one single object in the step S100. However, the CPU 110 can alternately obtain a document in which at least one object is located within a layout area. In this case, the CPU 110 specifies an object as a processing target to be processed, from among objects included in the document. Processing as described above is then executed on the specified object. Also in this case, object attribute information can be included in the obtained document. That is, the CPU 110 can obtain object attribute information related to the object as a processing target.

The above embodiment has been described with reference to an example which deals with an object as data expressing a text. However, the object can be data which expresses an image. Further, the CPU 110 can trim an object to cut out an image having a golden rectangle from the object. Alternately, the size of an object can be changed so that the object becomes a golden rectangle.

Functions other than those equivalent to the object obtaining unit 101 and the object edit unit 104 can be omitted.

### 2. Second Embodiment

Next, a second embodiment of the invention will be described. From the description below, explanation of common features with regard to the first embodiment will be omitted. Common components with regard to the first embodiment will be denoted with common reference numerals. According to the first embodiment, the size of a golden rectangle is changed based on a volume of an object and related object attribute information. In the second embodiment, the size of a golden rectangle is fixed, and an object is edited to fit into the golden rectangle.

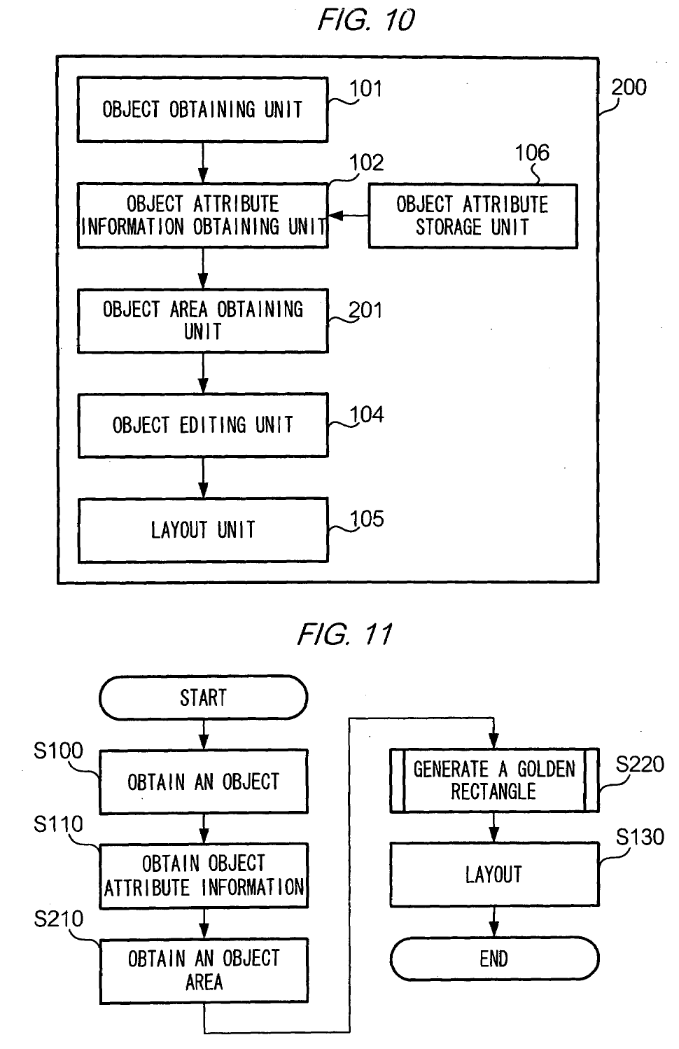

FIG. 10 is a block diagram showing a functional structure of a document edit device 200 according to the second embodiment. An object area obtaining unit 201 obtains information indicative of an object area L. Components other than the unit 201 are common with regard to the document edit device 100 in the first embodiment, and therefore, description of such common components will be omitted. Since a hardware structure common with regard to the first embodiment is utilized, description of the hardware structure will also be omitted.

FIG. 11 is a flowchart showing an operation of the document edit device 200 according to the second embodiment. The flow shown in FIG. 11 differs from the flow shown in FIG. 3 in that a processing (step S210) for obtaining an object area is added behind the step S110. Further, details of the process of forming a golden rectangle (step S220) are different from those described in the first embodiment.

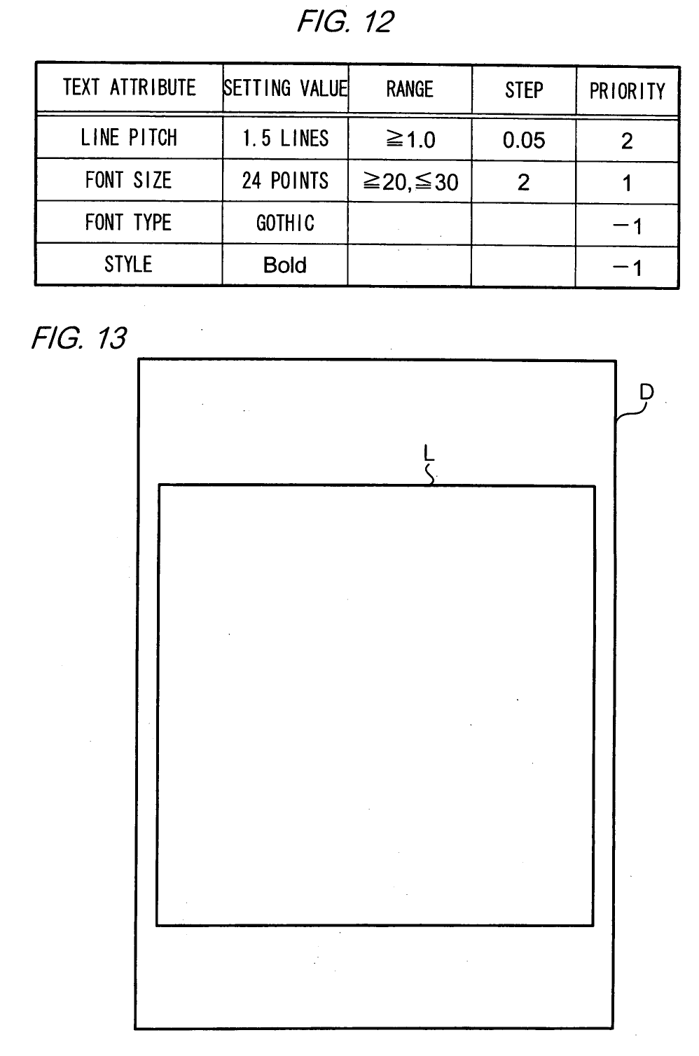

FIG. 12 shows an example of content attribute information in the second embodiment. In the second embodiment, content attribute information includes ranges of variations of setting values, and change amounts (steps) and priorities of the setting values, in addition to attribute identifiers and setting values related to the identifiers as have been described in the first embodiment. The priorities are each used to specify a target attribute to be changed when editing an object. Among the priorities, “1” indicates the highest priority and “2” indicates the second highest priority. The priority “−1” indicates that a setting value of an attribute related to the priority is a fixed value. In this embodiment, the font size is changed first and the line space is changed next while the font type and style are not changed.

In the step S210, the CPU 110 obtains information indicating an object area L. The information indicating an object area L can be determined in advance. Alternately, the CPU 110 can obtain information indicating an object area L in accordance with an instruction input by a user. Alternately, the information indicating an object area L can be stored in advance in the HDD 150, or in a device different from the document edit device 200.

FIG. 13 shows an example of an object area L. The object area L occupies a part of a layout area D. For example, the layout area D is an A4 size area. The object area L is a square area of 15 cm×15 cm positioned in the center of the layout area D.

FIG. 14 is a flowchart showing details of a process of forming a golden rectangle according to the second embodiment. In a step S221, the CPU 110 extracts a largest golden rectangle. The “largest golden rectangle” refers to a golden rectangle whose major or minor edge has a length equal to any of the edges of the object area L, among the golden rectangles which can be contained in the object area L. For example, in case of generating a wide golden rectangle, the CPU 110 determines the length A′ of the major edge of a golden rectangle to be equal to the length of a horizontal edge of the object area L. That is, A′=15 cm is given. Next, the CPU 110 calculates the length A of the minor edge of the golden rectangle in accordance with the formula (4). In this manner, a largest golden rectangle is obtained with the lengths of major and minor edges being A′ and A.

In a step S222, the CPU 110 temporarily lays out characters included in the object, within the largest golden rectangle.

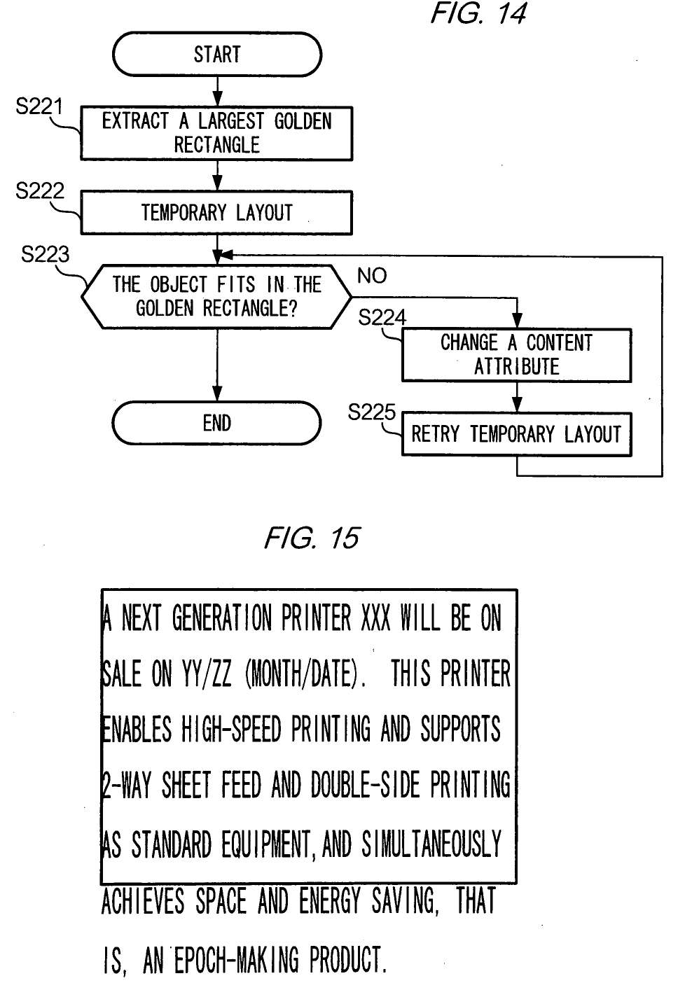

FIG. 15 shows an example of an object laid out temporarily. As shown in FIG. 15, as a result of temporary layout, characters of “achieves space and energy saving, that is, an epoch-making product” are out of the largest golden rectangle. In this case, the font size and line space of the object are set to 24 points and 1.5 lines

Description will now be made referring again to FIG. 14. In a step S223, the CPU 110 determines whether or not the object fits into the largest golden rectangle. That is, the CPU 110 determines whether the characters included in the object can be contained in the largest golden rectangle or not. Otherwise, the CPU 110 determines whether or not a blank space in the largest golden rectangle is smaller than a threshold. The “blank space” refers to areas other than an area occupied by the object (which is a text in this embodiment).

If the object is not determined to fit into the golden rectangle (S223: NO), the CPU 110 changes content attribute information, in a step S224. This processing is carried out as follows. The CPU 110 determines an attribute as a target to be changed, on the basis of priorities included in the content attribute information (FIG. 12). In this case, the attribute “font size” related to the highest priority is selected first as a target. The CPU 110 decrements the setting value of the selected attribute by one step. The content attribute information includes information indicating that the step of the attribute “font size” is “2”. Therefore, the CPU 110 changes the setting value of the attribute “font size” to 22 points by reducing two points from 24 points. The CPU 110 updates the content attribute information with the changed setting value. The CPU 110 further stores into the RAM 130 a flag indicating that the attribute “font size” has been changed. In a step S225, the CPU 110 temporarily lays out again the object, based on the updated content attribute information.

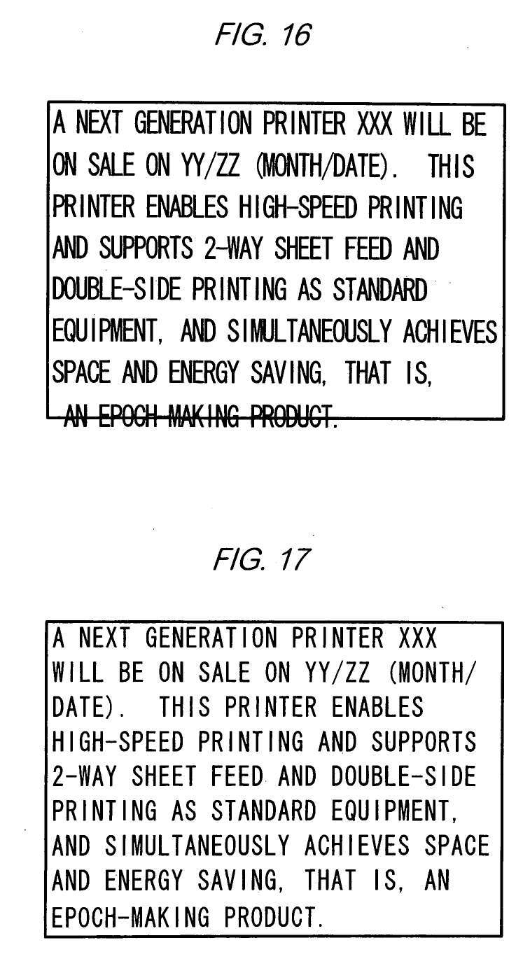

FIG. 16 shows an example of an object whose font size has been changed. Though the font size has been reduced, a part of the text “an epoch-making product.” is still outside the largest golden rectangle.

Description will now be made referring again to FIG. 14. Next in a step S223, the CPU 110 determines whether or not the object fits into the largest golden rectangle. As shown in FIG. 16, the object does not fit into the largest golden rectangle (step S223: NO). In a step S224, the CPU 110 changes content attribute information. With respect to the attribute “font size” given the highest priority, there has already been stored a flag indicating that the setting value has been changed. Therefore, the CPU 110 determines the attribute “line space” having the second highest priority to be a target to be changed. The CPU 110 decreases the setting value of the selected attribute by one step. The content attribute information includes information indicating that the step of the attribute “line space” is “0.05”. Accordingly, the CPU 110 changes the setting value of the attribute “line space” to 1.45 lines by reducing 0.05 lines from 1.5 lines. In addition, the CPU 110 updates the content attribute information with the changed setting value. The CPU 110 further stores into the RAM 130 a flag indicating that the attribute “line space” has been changed. In the step S225, the CPU 110 temporarily lays out again the object, based on the updated content attribute information.

FIG. 17 shows an example of an object whose line space has been changed. The object (character string) is properly contained in the largest golden rectangle. Thus, a document having a well-balanced layout is obtained.

Also in each of the above embodiments, the document edit program is stored in the HDD 150. However, the document edit program can be alternately provided by a storage medium such as a CD-ROM (Compact Disk Read Only Memory).

### BRIEF DESCRIPTION OF THE DRAWING

[FIG. 1] A block diagram showing a functional structure of a document edit device according to the first embodiment

[FIG. 2] A block diagram showing a hardware structure of the document edit device 100

[FIG. 3] A flowchart showing an operation of the document edit device 100

[FIG. 4] A table showing an example of an object attribute information obtained in the embodiment

[FIG. 5] A flowchart showing details of a process of forming a golden rectangle according to the first embodiment

[FIG. 6] A view showing an example of an object laid out temporarily

[FIG. 7] A view showing an example of a formed golden rectangle

[FIG. 8] A view showing another example of a golden rectangle

[FIG. 9] A view showing an example of a generated document

[FIG. 10] A block diagram showing a functional structure of a document edit device according to a second embodiment

[FIG. 11] A flowchart showing an operation of the document edit device 200

[FIG. 12] A table showing an example of object attribute information in the embodiment

[FIG. 13] A view showing an example of an object area L

[FIG. 14] A flowchart showing details of a process of forming a golden rectangle according to the second embodiment

[FIG. 15] A view showing an example of an object laid out temporarily

[FIG. 16] A view showing an example of an object after changing a font size

[FIG. 17] A view showing an example of an object after changing a line space

### EXPLANATION OF REFERENCE SYMBOLS

100 . . . Document edit device, 101 . . . Object obtaining unit, 102 . . . Object attribute obtaining unit, 104 . . . Object edit unit, 105 . . . Layout unit, 106 . . . Object attribute storage unit, 110 . . . CPU, 120 . . . ROM, 130 . . . RAM, 140 . . . I/F, 150 . . . HDD, 160 . . . Keyboard/mouse, 170 . . . Display, 180 . . . Network IF, 190 . . . Bus, 201 . . . Object area obtaining unit

What is claimed is:

1. A document editing device comprising:
an object obtaining unit that is configured to obtain an object including data indicative of a text;
an aspect ratio storage unit that is configured to store an aspect ratio within a predetermined range including a golden ratio; and
an object editing unit that is configured to edit the object by changing at least a location of the text so that a circumscribed rectangle of the text is a rectangle having two adjacent edges whose lengths form a ratio which complies with the aspect ratio stored in the aspect ratio storage unit.

2. The document editing device according to claim 1, wherein the aspect ratio r is within a range of
$$\sqrt{2} \leq r \leq 2 or \frac{1}{2} \leq r \leq \frac{1}{\sqrt{2}} .$$

3. The document editing device according to claim 2, wherein the aspect ratio falls within a range defined by an equation:
$$( 0.9 \times \frac{1 + \sqrt{5}}{2} ) \leq r \leq ( 1.1 \times \frac{1 + \sqrt{5}}{2} )$$
$$or \\ ( 0.9 \times \frac{2}{1 + \sqrt{5}} ) \leq r \leq ( 1.1 \times \frac{2}{1 + \sqrt{5}} ) .$$

4. The document editing device according to claim 3, wherein the aspect ratio is expressed by:
$$r = \frac{1 + \sqrt{5}}{2}$$
$$or$$
$$r = \frac{2}{1 + \sqrt{5}} .$$

5. The document editing device according to claim 1, further comprising
an object attribute obtaining unit that is configured to obtain object attribute information related to the object obtained by the object obtaining unit, from an attribute storage unit storing object attribute information indicating a font size and a line pitch of each object, wherein
the rectangle has a size which is determined based on the number of characters constituting the text and based on the object attribute information obtained by the object attribute obtaining unit.

6. The document editing device according to claim 1, further comprising
an object area obtaining unit that is configured to obtain information indicative of an object area, which limits an area where the object obtained by the object obtaining unit is to be located within a layout area corresponding to an output unit of a document edited by the document editing device, wherein
the rectangle has a size which is determined so as to be contained in the object area obtained by the object area obtaining unit.

7. The document editing device according to claim 5, further comprising a layout determination unit that is configured to locate the rectangle within the object area.

8. The document editing device according to claim 7, further comprising:
an attribute obtaining unit that is configured to obtain object attribute information related to the object obtained by the object obtaining unit, from an attribute storage unit which stores object attribute information indicating a font size and a line pitch of the text;
a largest rectangle determination unit that is configured to determine a largest rectangle within the object area, the largest rectangle having a major or minor edge whose length is equal to any of edges of the object area; and
a determination unit that is configured to determine whether or not the text indicated by the object and located in accordance with the object attribute information obtained by the attribute obtaining unit is contained in the largest rectangle determined by the largest rectangle determination unit, or whether or not a blank space in the largest rectangle is equal to or smaller than a threshold, wherein
if the determination unit determines that the object is not contained in the largest rectangle or that the blank space in the largest rectangle is equal to or greater than the threshold, the object editing unit changes the object attribute information.

9. The document editing device according to claim 1, wherein
the aspect ratio storage unit is configured to store a plurality of aspect ratios,
the object includes attribute information indicative of an attribute of the object itself,
the document editing device further includes an aspect ratio selection unit that is configured to select one aspect ratio from the plurality of aspect ratios stored in the aspect ratio storage unit, based on the attribute included in the object, and
the object editing unit is configured to edit the object by editing the location of the text so that a circumscribed rectangle of the text has two adjacent edges whose lengths form a ratio equal to the aspect ratio selected by the aspect ratio selection unit.

10. The document editing device according to claim 1, wherein
the aspect ratio storage unit is configured to store a plurality of aspect ratios,
a document as a target to be edited includes layout information indicative of location of the object included in the document,
the document editing device further includes an aspect ratio selection unit that is configured to select one aspect ratio from the plurality of aspect ratios stored in the aspect ratio storage unit, based on the layout information included in the document, and
the object editing unit is configured to edit the object by editing location of the text so that a circumscribed rectangle of the text has two adjacent edges whose lengths form a ratio equal to the aspect ratio selected by the aspect ratio selection unit.

11. The document editing device according to claim 1, wherein
the aspect ratio storage unit is configured to store a plurality of aspect ratios,
a document as a target to be edited includes background information indicative of a background,
the document editing device further includes an aspect ratio selection unit that is configured to select one aspect ratio from the plurality of aspect ratios stored in the aspect ratio storage unit, based on the background information included in the document, and
the object editing unit is configured to edit the object by editing the location of the text so that a circumscribed rectangle of the text has two adjacent edges whose lengths form a ratio equal to the aspect ratio selected by the aspect ratio selection unit.

12. A program causing a computer device having an aspect ratio storage unit that stores an aspect ratio within a predetermined range including a golden ratio to execute a process, the process comprising:
obtaining an object including data indicative of a text; and
editing an object by changing at least a location of the text so that a circumscribed rectangle of the text is a rectangle having two adjacent edges whose lengths form a ratio which complies with the aspect ratio stored in the aspect ratio storage unit.

13. A computer readable storage medium storing a program causing a computer device having an aspect ratio storage unit that stores an aspect ratio within a predetermined range including a golden ratio to execute a process, the process comprising:
obtaining an object including data indicative of a text; and
editing an object by changing at least a location of the text so that a circumscribed rectangle of the text is a rectangle having two adjacent edges whose lengths form a ratio which complies with the aspect ratio stored in the aspect ratio storage unit.
